(19) United States
(12) Patent Application Publication
(10) Pub. No.: US 2025/0283641 A1
(43) Pub. Date: Sep. 11, 2025

(54) REFRIGERANT MANIFOLD

(71) Applicant: Hanon Systems, Daejeon (KR)

(72) Inventor: Byung Joo KIM, Daejeon (KR)

(73) Assignee: Hanon Systems, Daejeon (KR)

(21) Appl. No.: 19/040,425

(22) Filed: Jan. 29, 2025

(30) Foreign Application Priority Data
Mar. 8, 2024 (KR) 10-2024-0033037

(51) Int. Cl. F25B 41/42

(52) U.S. Cl. CPC F25B 41/42; F25B 2500/222

(57) ABSTRACT

The present invention relates to a refrigerant manifold applied to a cooling module applied to a vehicle cooling system. According to the refrigerant manifold of the present invention, by forming a hole or a slit in a middle plate and a housing of parts to which in/out ports are connected or parts to which in/out pipes are connected to discharge a leaked fluid to the outside when leakage occurs inside a manifold, it is possible to increase the accuracy of a leakage test.

### CROSS REFERENCE TO RELATED APPLICATION

The present application claims priority to Korean Patent Application No. 10-2024-0033037, filed Mar. 8, 2024, the entire contents of which is incorporated herein for all purposes by this reference.

### BACKGROUND OF THE INVENTION

### Field of the Invention

The present invention relates to a refrigerant manifold applied to a cooling module applied to a vehicle cooling system.

### Description of the Related Art

Recently, as interest in energy efficiency and environmental pollution issues has increased day by day, the development of eco-friendly vehicles capable of practically replacing internal combustion engine vehicles has been demanded, and such eco-friendly vehicles are usually classified as electric vehicles driven by fuel cells or electricity, and hybrid electric vehicles driven by an engine and a battery.

Among these eco-friendly vehicles, electric vehicles or hybrid electric vehicles do not use a separate heater unlike air conditioning devices in general vehicles, and the air conditioning system applied to the eco-friendly vehicles is usually called a heat pump system.

Meanwhile, in the case of the electric vehicles, a driving force is generated by converting chemical reaction energy of oxygen and hydrogen into electric energy, and during such a process, heat energy is generated by a chemical reaction in the fuel cell, and thus it is essential to effectively remove the generated heat to secure the performance of the fuel cell.

In addition, in the hybrid electric vehicles, along with the engine operated by a general fuel, the fuel cells or electricity supplied from electric batteries are used to drive a motor to generate a driving force, and thus the performance of the motor can be secured only when the heat generated from the fuel cells or the batteries and the motor is effectively removed.

Accordingly, a cooling system, a heat pump system, and a battery cooling system are formed in conventional hybrid electric vehicles or electric vehicles. Accordingly, a refrigerant manifold is used to reduce the size and weight of the cooling module and simplify the layout of pipes connecting a plurality of heat exchangers and a plurality of valves.

The refrigerant manifold is formed in a structure in which a first housing, a middle plate, and a second housing are stacked and joined by brazing or a structure in which only the first housing and the middle plate are stacked and joined, and thus even when there is no problem in the result of evaluating refrigerant manifold leakage, there is a concern that internal leakage may occur between the first housing and the middle plate or between the second housing and the middle plate.

In particular, there is a problem that, when internal leakage occurs at a part in which heat exchanger in/out ports formed in the first housing are connected and a part in which the heat exchanger in/out pipes formed in the second housing are connected, it is highly likely that leakage is not detected during leakage evaluation, and when this is applied to an actual product, there is a high possibility that the leakage affects A/C performance, H/P performance, and battery performance.

### Related Art Document

(Patent Document 1) Korean Laid-Open Patent No. 10-2022-0162479 (entitled “INTEGRATED COOLING MODULE”)

### SUMMARY OF THE INVENTION

The present invention has been made in efforts to solve the above problems and is directed to providing a refrigerant manifold, in which a hole or a slit may be formed in a middle plate and a housing of parts to which in/out ports are connected or parts to which in/out pipes are connected to discharge a leaked fluid to the outside when leakage occurs inside a manifold, thereby increasing the accuracy of a leakage test.

To solve the above problem, a refrigerant manifold according to one embodiment of the present invention includes a first housing in which a first refrigerant channel is formed on one surface thereof and a component mounting portion on which a component is mounted is formed on the other surface, and a middle plate stacked on one surface of the first housing to cover and block the first refrigerant channel, wherein the middle plate includes a first leakage detection portion formed at a position corresponding to the component mounting portion of the first housing to discharge a fluid leaking from the first housing to the outside of a space formed by the first housing and the middle plate.

In addition, the component mounting portion includes a fluid outlet hole that transfers a fluid toward the component, and a fluid inlet hole that receives the fluid from the component and is formed at a position spaced a predetermined distance from the fluid outlet hole, and the first leakage detection portion includes a slit formed to pass through an area between the fluid outlet hole and the fluid inlet hole.

In addition, the component mounting portion includes a bolt fastening portion formed between the fluid outlet hole and the fluid inlet hole and including a hole or a groove into which a bolt is inserted to be fastened to the middle plate, the middle plate has each through hole formed at a position corresponding to the bolt fastening portion, and the slit is formed to connect the through holes.

In addition, the component mounting portion includes the fluid outlet hole that transfers the fluid toward the component, the fluid inlet hole that receives the fluid from the component and is formed at a position spaced a predetermined distance from the fluid outlet hole, and a bolt fastening portion formed between the fluid outlet hole and the fluid inlet hole and including a hole or a groove into which a bolt is inserted to be fastened to the middle plate, the first leakage detection portion includes a plate-shaped first cover provided at a position corresponding to the fluid outlet hole and coupled to the component mounting portion, and a plate-shaped second cover provided at a position corresponding to the fluid inlet hole and coupled to the component mounting portion, and the first cover and the second cover are formed of separate components and provided at positions spaced a predetermined distance from each other.

In addition, the first leakage detection portion further includes a plate-shaped third cover formed of a component separately from the first cover and the second cover, provided at a position corresponding to the bolt fastening portion, and coupled to the component mounting portion.

In addition, the third cover is a flat plate formed integrally with the component mounting portion or attached to one surface of the component mounting portion.

In addition, a thickness of the third cover is greater than a thickness of the first cover or the second cover.

In addition, a thickness of the third cover is greater than an average thickness of the middle plate.

A refrigerant manifold according to one embodiment of the present invention includes a first housing in which a first refrigerant channel is formed on one surface thereof and a component mounting portion on which a component is mounted is formed on the other surface, a middle plate stacked on one surface of the first housing to cover and block the first refrigerant channel, and a second housing in which a second refrigerant channel is formed on the other surface thereof and which is stacked on one surface of the middle plate, wherein the second housing includes a second leakage detection portion formed at a position at which it is in contact with the second refrigerant channel to discharge a fluid leaking from the second housing to the outside of a space formed by the second housing and the middle plate.

In addition, the second refrigerant channel is formed as two or more second refrigerant channels in the second housing, the second refrigerant channels each extend in the same direction and are formed to be spaced a predetermined distance from each other, and the second leakage detection portion includes a first leakage hole formed between the second refrigerant channels.

In addition, the first leakage hole is formed as two or more first leakage holes in an extension direction of the second refrigerant channel.

In addition, the second refrigerant channel includes at least one bent portion at which the extension direction changes, and the first leakage hole is formed at a position at which it is in contact with the bent portion of the second refrigerant channel.

In addition, the middle plate includes a second leakage hole formed to pass therethrough at a position corresponding to the first leakage hole.

### BRIEF DESCRIPTION OF THE DRAWINGS

FIG. 1 is an exploded perspective view illustrating a refrigerant manifold of the present invention.

FIG. 2 is a perspective view illustrating the entire refrigerant manifold of the present invention.

FIG. 3 is a partial perspective view illustrating a component mounting portion of the present invention.

FIG. 4 is a plan view illustrating a first leakage detection portion according to a first embodiment of the present invention.

FIG. 5 is a schematic view illustrating the first leakage detection portion according to the first embodiment of the present invention.

FIG. 6 is a plan view illustrating a first leakage detection portion according to a second embodiment of the present invention.

FIG. 7 is a schematic view illustrating the second leakage detection portion according to the second embodiment of the present invention.

FIG. 8 is a perspective view illustrating the entire refrigerant manifold of the present invention.

FIG. 9 is a plan view illustrating a second leakage detection portion of the present invention.

FIG. 10 is a schematic view illustrating the second leakage detection portion of the present invention.

FIG. 11 is a schematic view illustrating the second leakage detection portion according to one embodiment of the present invention.

### DETAILED DESCRIPTION OF THE INVENTION

Hereinafter, the technical spirit of the present invention will be described in more detail with reference to the accompanying drawings. The terms or words used in the present specification and claims are not to be narrowly interpreted according to their general or dictionary meanings and should be interpreted as having meanings and concepts that are consistent with the technical idea of the present disclosure on the basis of the principle that an inventor can be his/her own lexicographer to appropriately define concepts of terms to describe his/her invention in the best way.

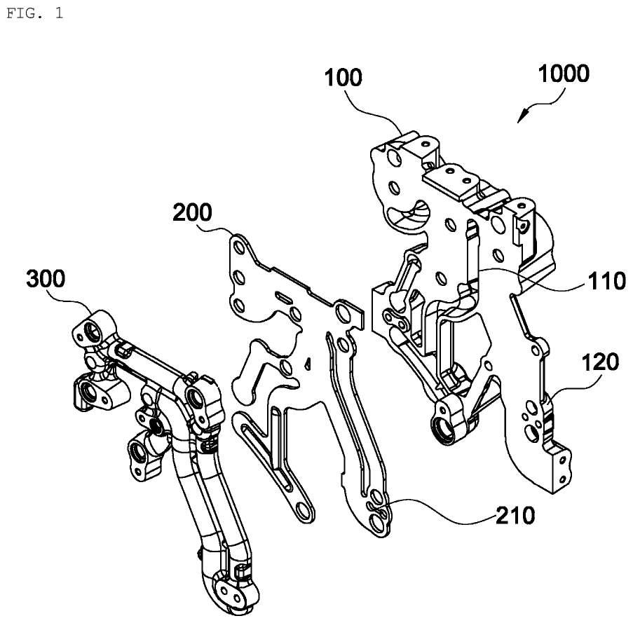

Hereinafter, a refrigerant manifold 1000 according to a first embodiment of the present invention will be described with reference to FIGS. 1 to 3.

As illustrated in FIG. 1, the present invention may include a first housing 100 and a middle plate 200. More specifically, the first housing 100 is one of components coupled to the middle plate 200 to form a refrigerant flow path through which refrigerant flows, a plurality of first refrigerant channels 110 through which refrigerant flows may be concavely formed on one surface of the first housing 100, and one or more component mounting portions 120 on which components are mounted may be formed on the other surface of the first housing 100. In this case, the component is a target component coupled to the first housing 100 and may be a heat exchanger that uses refrigerant flowing in the cooling channel of the first housing 100. Here, the heat exchanger may be any type of heat exchanger. For example, the heat exchanger may be a water-cooled condenser, a chiller, and the like. In addition, the component may be any component.

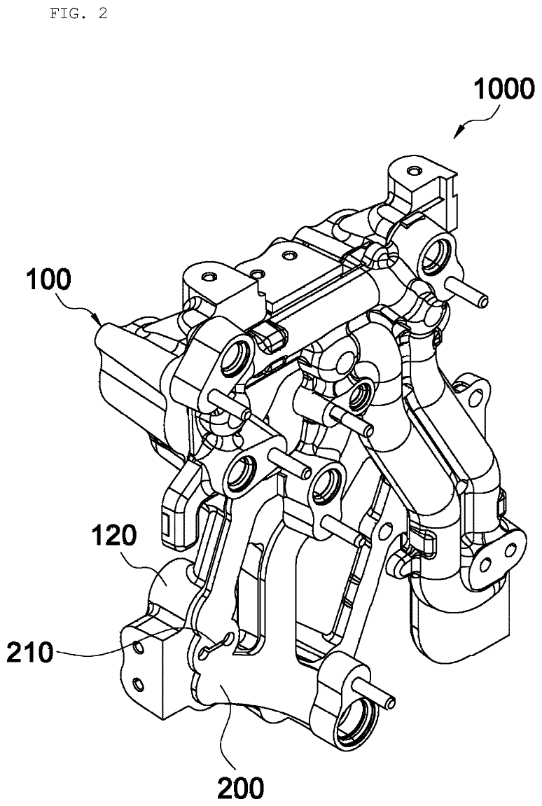

In addition, the middle plate 200 may be formed in a flat plate shape and stacked on one surface of the first housing 100 to cover and block the first refrigerant channels 110. In this case, as illustrates in FIG. 2, the middle plate 200 may include a first leakage detection portion 210 formed at a position corresponding to the component mounting portion 120 of the first housing 100 to discharge a fluid leaking from the first housing 100 to the outside of the first refrigerant channels 110, more specifically, to the outside of the component mounting portion 120.

By including the first leakage detection portion 210, the refrigerant manifold 1000 according to the first embodiment of the present invention may discharge the leaked refrigerant to the outside through the first leakage detection portion 210 even when refrigerant leaks between the first housing 100 and the middle plate 200, that is, therein, thereby more smoothly checking whether leakage occurs when a leakage test is performed on the refrigerant manifold 1000 of the present invention.

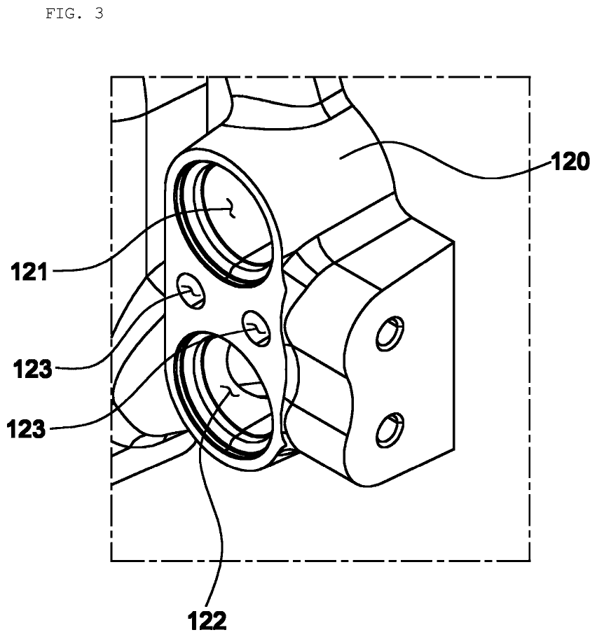

In addition, as illustrated in FIG. 3, the component mounting portion 120 may have a shape that protrudes from a curved shape of the other surface of the first housing 100, and a surface of the component mounting portion 120 to which the component is coupled may be formed flat. In addition, the component mounting portion 120 may include a fluid outlet hole 121 that transfers a fluid toward the component and a fluid inlet hole 122 that receives a fluid from the component and is formed at a position spaced a predetermined distance from the fluid outlet hole 121. In addition, the component mounting portion 120 may include a bolt fastening portion 123 that is formed between the fluid outlet hole 121 and the fluid inlet hole 122 and includes a hole or a groove into which a bolt is inserted to be fastened to the middle plate 200.

Since the component mounting portion 120 includes the bolt fastening portion 123, the middle plate 200 and the first housing 100 may be fixed. In this case, a head portion of the bolt fastened to the bolt fastening portion 123 may be fastened to press the first housing 100 without pressing the middle plate 200, thereby minimizing the deformation of the middle plate 200 having a flat plate shape and minimizing the leakage of the refrigerant.

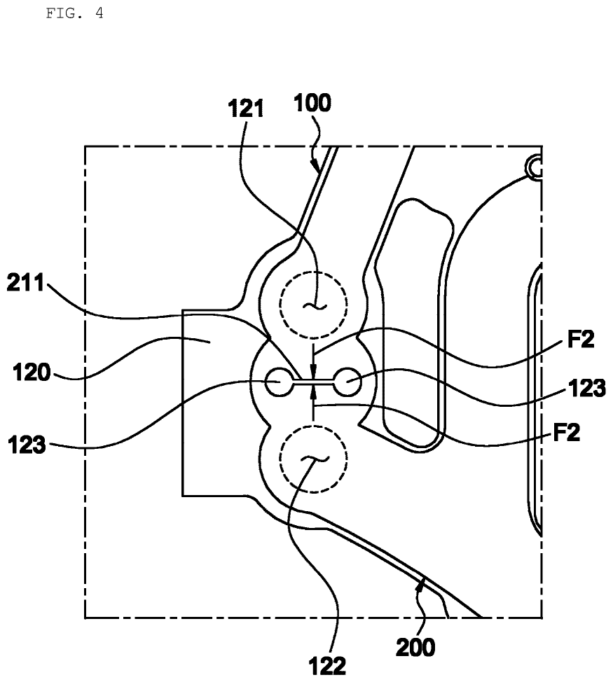

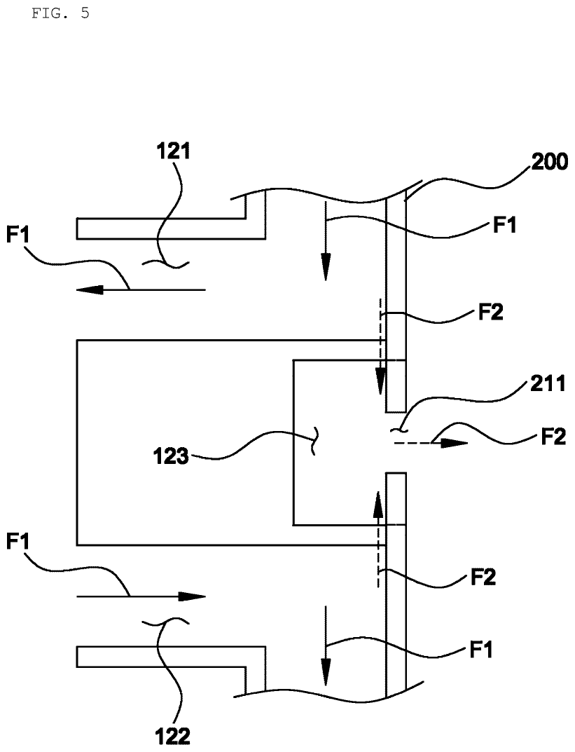

Hereinafter, the first leakage detection portion 210 according to the first embodiment of the present invention will be described in more detail with reference to FIGS. 4 and 5.

As illustrated in FIG. 4, in the first leakage detection portion 210 according to the first embodiment, the first leakage detection portion 210 may include a slit 211 formed to pass through an area between the fluid outlet hole 121 and the fluid inlet hole 122. Accordingly, as illustrated in FIG. 5, when refrigerant leaks at a coupling portion between the fluid outlet hole 121 and the middle plate 200 as long as the flow of the normally flowing refrigerant is not obstructed, the uncooled refrigerant can be prevented from flowing into the fluid inlet hole along the surface of the middle plate 200. That is, the leaked refrigerant may be discharged through the slit 211 along a contact surface of the middle plate 200 and the first housing 100. Accordingly, the efficiency of the refrigerant manifold 1000 can be prevented from being lowered, and the leaked refrigerant can be discharged to the outside of the cooling channel, and thus it can be confirmed that leakage has occurred during leakage test.

In addition, the middle plate 200 may have through holes formed at positions corresponding to the bolt fastening portions, and the slits 211 may be formed to connect the through holes. Accordingly, when refrigerant leaks, the leaked refrigerant may smoothly move along the bolt fastened to the bolt fastening portion 123 toward the slit 211, and it is possible to more clearly confirm that leakage has occurred during a refrigerant leakage test.

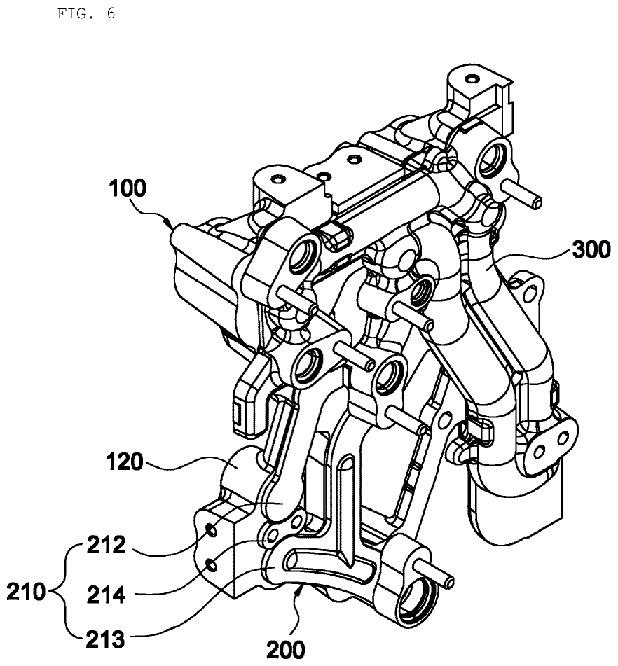

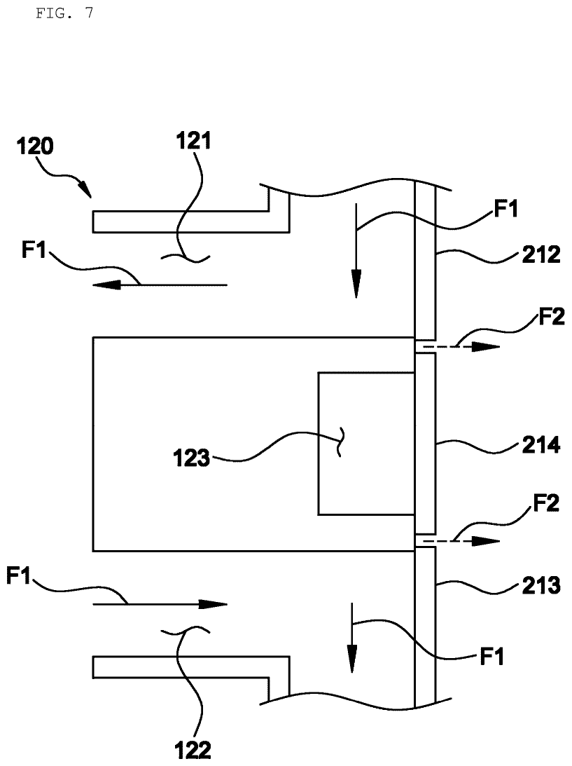

Hereinafter, the first leakage detection portion 210 according to the second embodiment of the present invention will be described in more detail with reference to FIGS. 6 and 7.

As illustrated in FIG. 6, in the first leakage detection portion 210 according to the first embodiment, the first leakage detection portion 210 may include a plate-shaped first cover 212 provided at a position corresponding to the fluid outlet hole 121 and coupled to the component mounting portion 120, and a plate-shaped second cover 213 provided at a position corresponding to the fluid inlet hole 122 and coupled to the component mounting portion 120, and the first cover 212 and the second cover 213 may be formed of separate components and provided at positions spaced a predetermined distance from each other.

Furthermore, in the present embodiment, the first leakage detection portion 210 may further include a plate-shaped third cover 214 that is formed as a component separately from the first cover 212 and the second cover 213, provided at a position corresponding to the bolt fastening portion 123, and coupled to the component mounting portion 120. The third cover 214 may be formed integrally with the component mounting portion 120 or may be a flat plate attached to one surface of the component mounting portion 120. A thickness of the third cover 214 may be greater than a thickness of the first cover 212 or the second cover 213 or may be formed to be greater than an average thickness of the middle plate 200. By including the third cover 214, it is easy to use a tool, such as a spanner, a socket wrench, or the like, to fasten the bolt fastened to the bolt fastening portion 123, and the rigidity of a portion to which a fastening member is joined can be increased.

By applying the first leakage detection portion 210 according to the second embodiment, as illustrated in FIG. 7, when refrigerant leaks at the coupling portion of the fluid outlet hole 121 and the middle plate 200 as long as the flow of the normally flowing refrigerant is not obstructed, the uncooled refrigerant can be prevented from flowing into the fluid inlet hole along the surface of the middle plate 200. That is, the leaked refrigerant may be discharged between the first cover 212 and the second cover 213 or between the first cover 212 and the second cover 213 and the third cover 214 along the contact surface of the middle plate 200 and the first housing 100. Accordingly, the efficiency of the refrigerant manifold 1000 can be prevented from being lowered, and the leaked refrigerant can be discharged to the outside of the cooling channel, and thus it can be confirmed that leakage has occurred during leakage test.

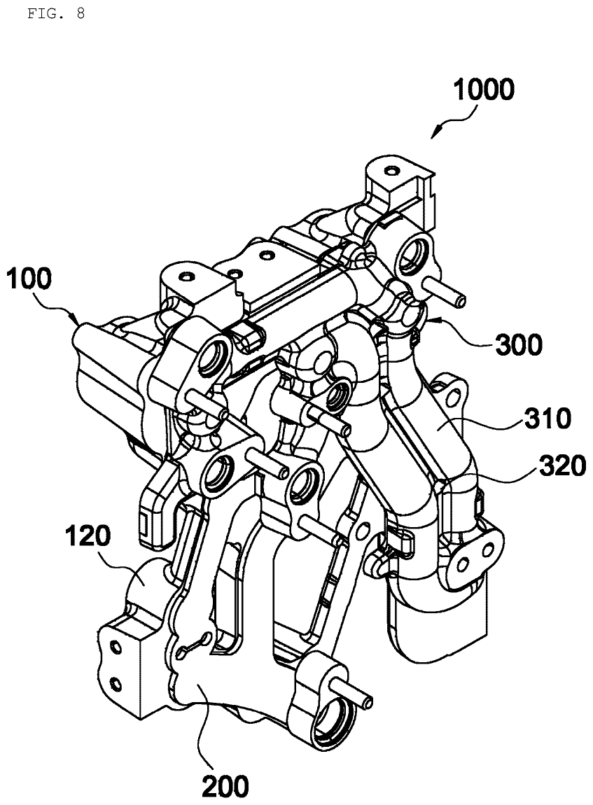

Hereinafter, a basic configuration of the refrigerant manifold 1000 according to the second embodiment of the present invention will be described with reference to FIG. 8.

As illustrated in FIG. 8, the refrigerant manifold 1000 of the present invention may further include the first housing 100 in which the first refrigerant channel 110 is formed concavely on one surface thereof and the component mounting portion 120 on which a component is mounted is formed on the other surface, the middle plate 200 stacked on one surface of the first housing 100 to cover and block the first refrigerant channel 110, and the second housing 300 in which a second refrigerant channel 310 is formed concavely on the other surface thereof and which is stacked on one surface of the middle plate 200.

The second housing 300 is a component coupled to the middle plate 200 to form a refrigerant flow path through which refrigerant flows, the second refrigerant channel 310 may be formed concavely on the other surface of the second housing 300, and the second housing 300 may include a refrigerant port connected to the second refrigerant channel 310. The second housing 300 may be stacked on one surface of the middle plate 200 and joined by brazing. That is, the second housing 300 may be disposed at one side of the middle plate 200, and the first housing 100 may be disposed at the other side. Accordingly, the refrigerant manifold 1000 of the present invention may form a more diverse refrigerant flow path using the second housing 300. In addition, the second housing 300 may be formed to correspond to some areas of the middle plate 200, and in this case, a part of the entire one surface of the remaining area of the middle plate 200 that does not correspond to the second housing 300 may be exposed to the outside.

In addition, the second housing 300 may include a second leakage detection portion 320. The second leakage detection portion 320 may be formed at a position at which it is in contact with the second refrigerant channel 310 to discharge a fluid leaking from the second housing 300 to the outside of a space formed by the second housing 300 and the middle plate 200. By including the second leakage detection portion 320, the refrigerant manifold 1000 according to the first embodiment of the present invention may discharge the leaked refrigerant to the outside through the second leakage detection portion 320 even when refrigerant leaks between the second housing 300 and the middle plate 200, that is, therein, thereby more smoothly checking whether leakage occurs when a leakage test is performed on the refrigerant manifold 1000 of the present invention.

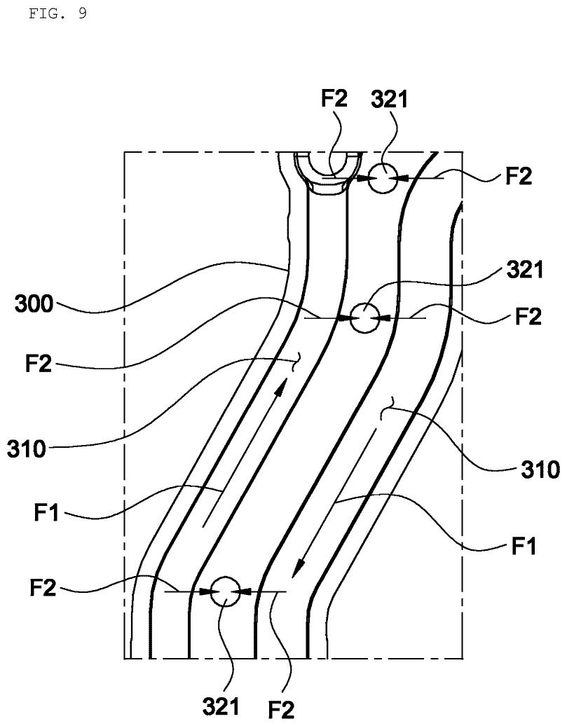

Hereinafter, the second leakage detection portion 320 of the present invention will be described in more detail with reference to FIGS. 9 to 11.

As illustrated in FIG. 9, the second housing 300 may be formed with two or more refrigerant channels, each refrigerant channel may be formed to extend in the same direction and spaced a predetermined distance from each other, and the second leakage detection portion 320 may include a first leakage hole 321 formed between the second refrigerant channels 310. In this case, two or more first leakage holes 321 may be formed in an extension direction of the refrigerant channel, and the number of first leakage holes 321 may be formed to a limit in which a durability problem does not occur considering materials and shapes of the second housing 300 and the middle plate 200.

In addition, the second refrigerant channel 310 may include at least one bent portion at which the extension direction changes, and the first leakage hole 321 may be formed at a position at which it is in contact with the bent portion of the refrigerant channel. That is, when the second housing 300 is coupled to the middle plate 200, the probability that compression does not occur completely is high, and thus by forming the first leakage hole 321 on the bent portion of the second refrigerant channel 310, which is a portion with a high possibility of leakage, more accurate results can be derived during a refrigerant leakage test.

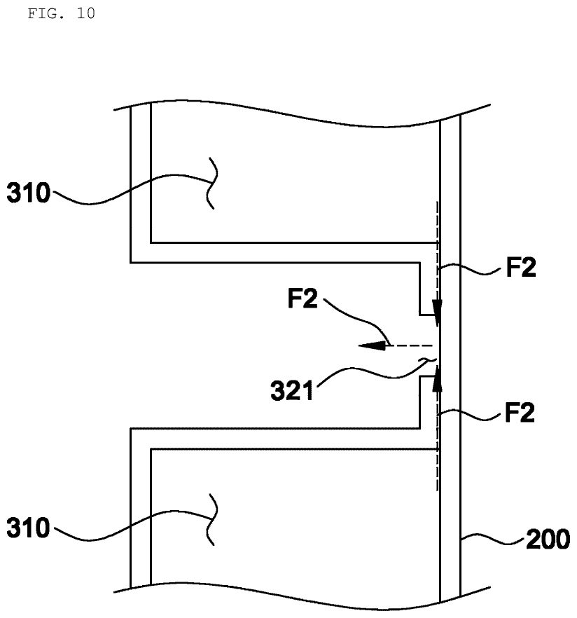

In addition, in one embodiment, as illustrated in FIG. 10, the middle plate 200 may include a second leakage hole 215 formed to pass through a position corresponding to the first leakage hole 321. Accordingly, the leaked refrigerant may be discharged more smoothly to the outside of the refrigerant manifold 1000, thereby increasing the accuracy of the refrigerant leak test.

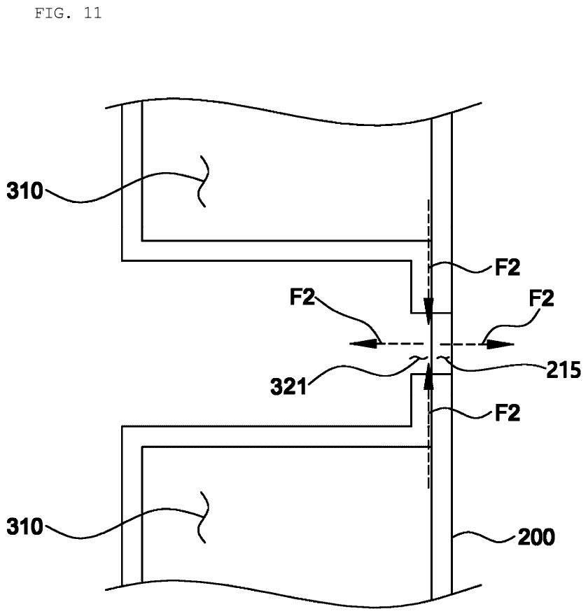

By applying the refrigerant manifold 1000 according to the second embodiment, as illustrated in FIG. 11, when refrigerant leaks at an overlapping portion of the second cooling channel and the middle plate 200 as long as the flow of the normally flowing refrigerant is not obstructed, the uncooled refrigerant can be prevented from flowing into adjacent other second cooling channels along the surface of the middle plate 200. That is, the leaked refrigerant may be discharged through the first leakage hole 321 and the second leakage hole 215 along the contact surface of the middle plate 200 and the first housing 100. Accordingly, the efficiency of the refrigerant manifold 1000 can be prevented from being lowered, and the leaked refrigerant can be discharged to the outside of the cooling channel, and thus it can be confirmed that leakage has occurred during leakage test.

According to the refrigerant manifold according to the above configuration, by forming the hole or the slit in the middle plate and the housing of the parts to which the in/out ports are connected or the parts to which the in/out pipes are connected to discharge the leaked fluid to the outside when leakage occurs inside a manifold, it is possible to increase the accuracy of the leakage test.

The technical spirit of the present invention should not be construed as limited to the above-described embodiments. Not only the scope of applications is diverse, but also various modifications may be made by those skilled in the art without departing from the gist of the present invention as claimed in the claims. Therefore, these improvements and changes fall within the scope of the present invention as long as they are obvious to those skilled in the art.

### DESCRIPTION OF REFERENCE NUMERALS

1000: refrigerant manifold
100: first housing
110: first cooling channel
120: component mounting portion
121: fluid outlet hole
122: fluid inlet hole
123: bolt fastening portion
200: middle plate
210: first leakage detection portion
211: slit
212: first cover
213: second cover
214: third cover
215: second leakage hole
300: second housing
310: second refrigerant channel
320: second leakage detection portion
321: first leakage hole
F1: normally flowing fluid
F2: leaked fluid

What is claimed is:

1. A refrigerant manifold comprising:
a first housing in which a first refrigerant channel is formed on one surface thereof and a component mounting portion on which a component is mounted is formed on the other surface; and
a middle plate stacked on one surface of the first housing to cover and block the first refrigerant channel,
wherein the middle plate includes a first leakage detection portion formed at a position corresponding to the component mounting portion of the first housing to discharge a fluid leaking from the first housing to the outside of the first refrigerant channel.

2. The refrigerant manifold of claim 1, wherein the component mounting portion includes:
a fluid outlet hole that transfers a fluid toward the component; and
a fluid inlet hole that receives the fluid from the component and is formed at a position spaced a predetermined distance from the fluid outlet hole, and
the first leakage detection portion includes a slit formed to pass through an area between the fluid outlet hole and the fluid inlet hole.

3. The refrigerant manifold of claim 2, wherein the component mounting portion includes a bolt fastening portion formed between the fluid outlet hole and the fluid inlet hole and including a hole or a groove into which a bolt is inserted to be fastened to the middle plate,
the middle plate has each through hole formed at a position corresponding to the bolt fastening portion, and
the slit is formed to connect the through holes.

4. The refrigerant manifold of claim 3, wherein the component mounting portion includes:
the fluid outlet hole that transfers the fluid toward the component;
the fluid inlet hole that receives the fluid from the component and is formed at a position spaced a predetermined distance from the fluid outlet hole, and
a bolt fastening portion formed between the fluid outlet hole and the fluid inlet hole and including a hole or a groove into which a bolt is inserted to be fastened to the middle plate,
the first leakage detection portion includes:
a plate-shaped first cover provided at a position corresponding to the fluid outlet hole and coupled to the component mounting portion; and
a plate-shaped second cover provided at a position corresponding to the fluid inlet hole and coupled to the component mounting portion, and
the first cover and the second cover are formed of separate components and provided at positions spaced a predetermined distance from each other.

5. The refrigerant manifold of claim 4, wherein the first leakage detection portion further includes a plate-shaped third cover formed of a component separately from the first cover and the second cover, provided at a position corresponding to the bolt fastening portion, and coupled to the component mounting portion.

6. The refrigerant manifold of claim 5, wherein the third cover is a flat plate formed integrally with the component mounting portion or attached to one surface of the component mounting portion.

7. The refrigerant manifold of claim 5, wherein a thickness of the third cover is greater than a thickness of the first cover or the second cover.

8. The refrigerant manifold of claim 5, wherein a thickness of the third cover is greater than an average thickness of the middle plate.

9. A refrigerant manifold comprising:
a first housing in which a first refrigerant channel is formed on one surface thereof and a component mounting portion on which a component is mounted is formed on the other surface;
a middle plate stacked on one surface of the first housing to cover and block the first refrigerant channel; and
a second housing in which a second refrigerant channel is formed on the other surface thereof and which is stacked on one surface of the middle plate,
wherein the second housing includes a second leakage detection portion formed at a position at which it is in contact with the second refrigerant channel to discharge a fluid leaking from the second housing to the outside of a space formed by the second housing and the middle plate.

10. The refrigerant manifold of claim 9, wherein the second refrigerant channel is formed as two or more second refrigerant channels in the second housing,
the second refrigerant channels each extend in the same direction and are formed to be spaced a predetermined distance from each other, and
the second leakage detection portion includes a first leakage hole formed between the second refrigerant channels.

11. The refrigerant manifold of claim 10, wherein the first leakage hole is formed as two or more first leakage holes in an extension direction of the second refrigerant channel.

12. The refrigerant manifold of claim 10, wherein the second refrigerant channel includes at least one bent portion at which the extension direction changes, and
the first leakage hole is formed at a position at which it is in contact with the bent portion of the second refrigerant channel.

13. The refrigerant manifold of claim 10, wherein the middle plate includes a second leakage hole formed to pass therethrough at a position corresponding to the first leakage hole.
